(19) United States
(12) Patent Application Publication
(10) Pub. No.: US 2012/0206250 A1
(43) Pub. Date: Aug. 16, 2012

(54) SPEED BUMP ALERTING SYSTEM

(75) Inventor: WALEED MOHAMAD JAN, RIYADH (SA)

(73) Assignee: KING FAHD UNIVERSITY OF PETROLEUM AND MINERALS, DHAHRAN (SA)

(21) Appl. No.: 13/026,071

(22) Filed: Feb. 11, 2011

(51) Int. Cl. B60Q 1/00

(52) U.S. Cl. 340/435

(57) ABSTRACT

The speed bump alerting system includes an ultra high frequency (UHF) radio frequency identifier (RFID) transponder disposed on a speed bump sign, and a UHF RFID reader disposed in the vehicle. The RFID reader connects to the vehicle's computer for sending speed bump data thereto. An external antenna connects to the RFID reader and is mounted to an exterior place on the vehicle. As the vehicle approaches the speed bump sign, the interrogator reads the sign mounted RFID transponder, which responds with a speed bump notification that is forwarded to the on-board computer, which posts an alert to the vehicle's display and causes the vehicle sound system to beep, thereby warning the driver to slow down for an oncoming speed bump. When the motorist slows the vehicle to an acceptable speed, the beep will stop.

### BACKGROUND OF THE INVENTION

1. Field of the Invention

The present invention relates to on-board vehicle alerting systems, and particularly to a speed bump alerting system that alerts the driver when the vehicle is approaching a speed bump.

2. Description of the Related Art

Drivers need a variety of warning systems to protect their automobiles from being damaged, and to safeguard the drivers and their passengers from getting hurt via muscle strain, impact against vehicle components, and the like due to sudden or unpredictable vehicle motion. When a vehicle hits a speed bump at a high rate of speed, such injuries and vehicle damage are likely to occur. Moreover, pedestrians relying on a speed bump to cross the street safely may suddenly encounter a high-speed vehicle careening out of control towards them. There is a need for an appropriate warning system so that the driver can apprehend an approaching speed bump and slow down accordingly.

Thus, a speed bump alerting system solving the aforementioned problems is desired.

### SUMMARY OF THE INVENTION

The speed bump alerting system includes a passive, ultra high frequency (UHF) radio frequency identifier (RFID) tag (also referred to herein as a transponder) disposed on a speed bump alert sign, and a UI-IF RFID reader (interrogator) disposed in the vehicle. The RFID reader connects to the vehicle's computer for signal processing of output from the RFID reader. The RFID reader is connected to an external antenna that is mounted to any suitable exterior place on the car's body.

As the vehicle approaches the speed bump sign, the on-board interrogator reads the sign-mounted RFID transponder, which responds by transmitting “speed bump nearby” data to the interrogator, which notifies the on-board computer so that the computer posts the alert to the vehicle's display and causes the vehicle sound system to beep, thereby warning the driver to slow down for an oncoming speed bump. As the motorist slows the vehicle to an acceptable speed, the beep will stop. The interrogator is energized by the car's battery, while the tag does not need a battery because it is energized by the interrogation signal sent from the interrogator.

These and other features of the present invention will become readily apparent upon further review of the following specification and drawings.

### BRIEF DESCRIPTION OF THE DRAWINGS

FIG. 1 is a block diagram of a speed bump alerting system according to the present invention.

FIG. 2 is a diagrammatic side view showing operation of a speed bump alerting system according to the present invention.

FIG. 3 is a perspective view of the rear of a speed bump sign having an RFID tag component a speed bump alerting system according to the present invention mounted thereon.

Similar reference characters denote corresponding features consistently throughout the attached drawings.

### DETAILED DESCRIPTION OF THE PREFERRED EMBODIMENTS

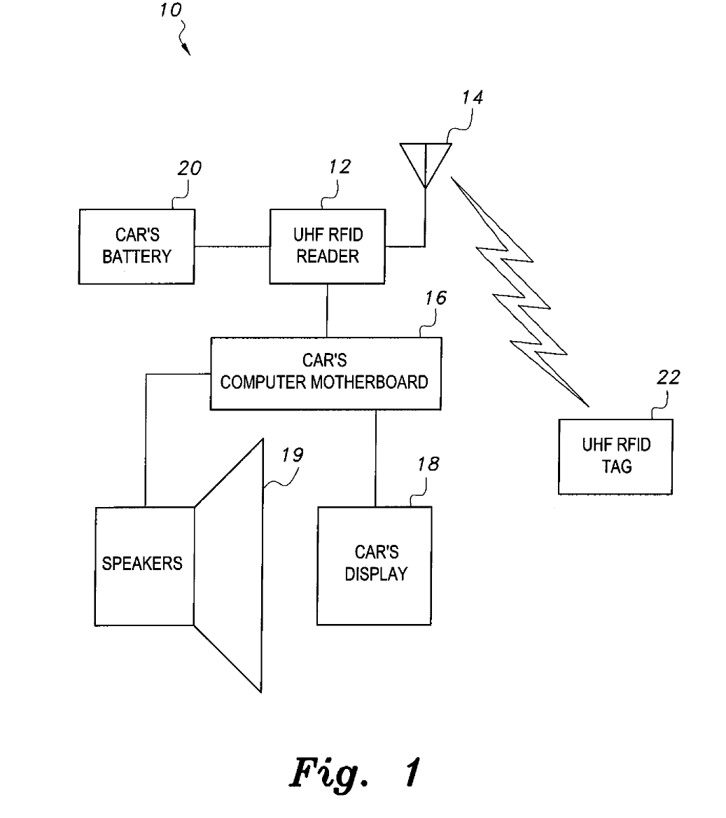

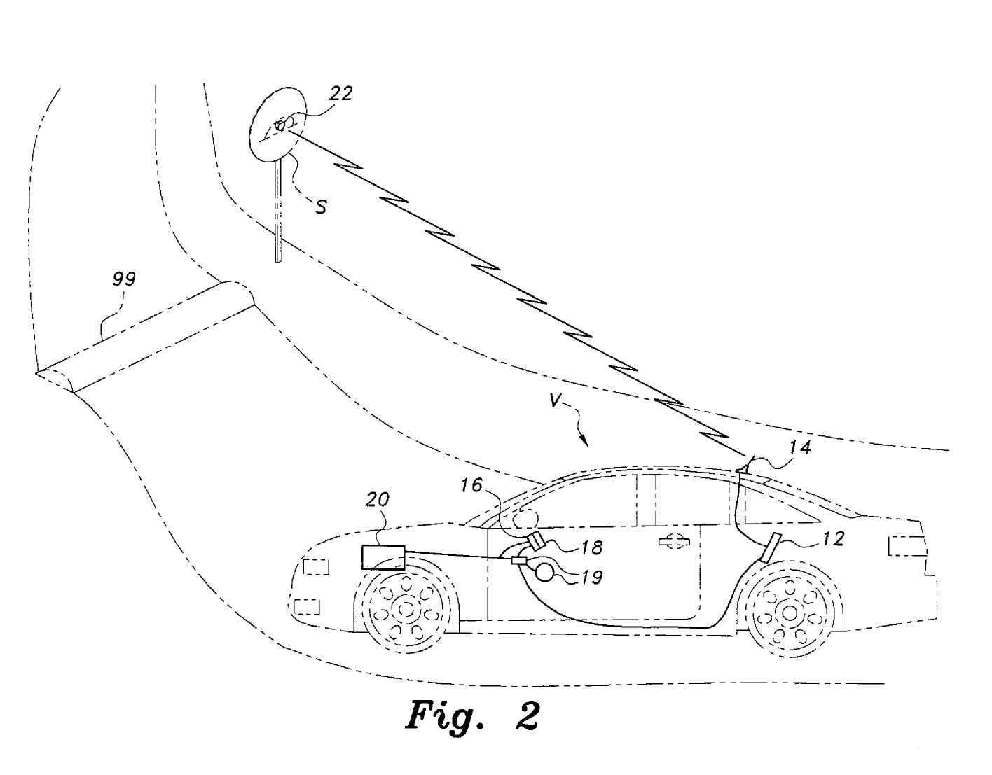

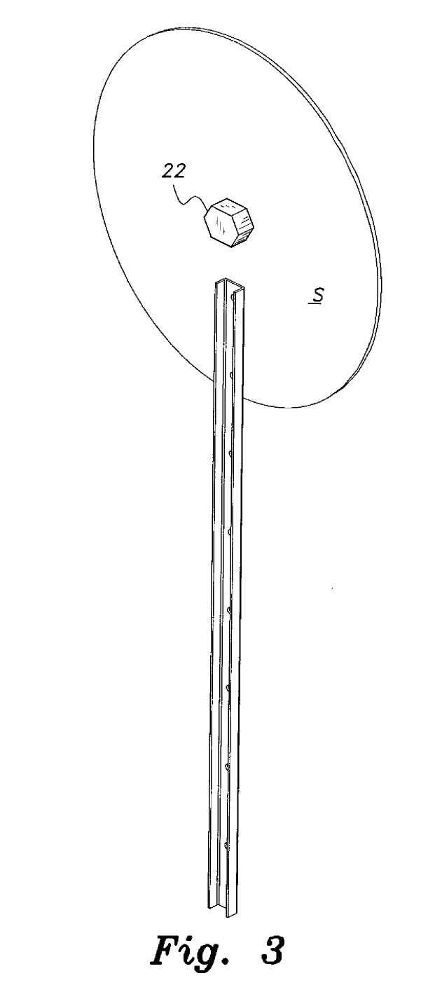

As shown in FIGS. 1-3, the speed bump alerting system 10 includes a passive, ultra high frequency (UHF) radio frequency identifier (RFID) transponder tag 22 disposed on a speed bump alert sign S, and a UHF RFID reader 12 disposed in the vehicle V. The transponder tag 22 is pre-programmed with a transmit message indicating that a speed bump is nearby. The RFID reader 12 is a short range transceiver that connects to the vehicle's computer 16 for signal processing of output from the RFID reader (interrogator) 12. The RFID reader 12 is connected to an external antenna 14 that is mounted to any suitable exterior place on the body of vehicle V. The vehicle computer 16 is connected to speakers 19 and to a display unit 18 for audio and visual alerting of the vehicle's driver.

As the vehicle V approaches the speed bump sign S, the on-board interrogator 12 transmits RF energy to wake-up the RFID transponder tag 22 mounted on the sign S and then receives the “speed bump nearby” notification data returned by the RFID transponder 22. The interrogator 12 then relays this information to the on-board computer 16, which posts the alert to the display 18 inside the vehicle V and causes the vehicle sound system 19 to beep, thereby warning the driver to slow down for an oncoming speed bump 99. In some embodiments, in addition to transmitting a signal warning of proximity to the speed bump, the tag 22 may also transmit the speed limit. The car's computer 16 may be programmed so that the audio alert is not emitted unless the motorist is exceeding the speed limit, and when the motorist slows the vehicle V to an acceptable speed, the beep will stop. The interrogator 12 is energized by the car's battery 20, while the RFID tag 22 is energized by RF energy from the interrogator 12.

It is expected that the range of system 10 provides driver notification of approximately ten meters before the speed bump. Preferably, the UHF RFID reader 12 is mounted in the trunk of vehicle V. The antenna is preferably mounted on the rooftop of vehicle V.

The UHF RFID tag 22 is operable between the 865-868 MHz and 902-928 MHZ frequency bands. Moreover, the RFID tag 22 is water-and impact-resistant, and functions well under a low to high temperature range of between −40° C. and +70° C. The interrogator 12 is operable between temperatures ranging from −40° C. to +55° C., and at frequencies ranging between 865 and 868 MHz. The interrogator 12 can read the RFID transponder tag 22 notwithstanding vehicle speeds up to 150 km/h. Also the vehicle mounted component parts of the system 10 can be sold in car shops as an upgrade kit for any one who wants to add this feature to his/her car. The kit could include an interrogator 12 and an antenna 14. The kit may also include a wiring harness or wiring harnesses for connecting the interrogator 12 to a computer arranged inside the vehicle, and for connecting the computer to speakers, buzzers, and the like arranged inside the vehicle for audio alerts, and to an electronic screen, display, or the like arranged inside the vehicle for visual alerts. It is expected that the Highway Department will install the transponders 22 on the appropriate speed bump signs S.

It is to be understood that the present invention is not limited to the embodiments described above, but encompasses any and all embodiments within the scope of the following claims.

I claim:

1. A speed bump alerting system, comprising:
a radio frequency identifier (RFID) interrogator adapted for mounting in a vehicle, the RFID interrogator being operable to send a speed bump notification signal when the vehicle approaches a speed bump having a corresponding RFID tag mounted in proximity thereto;
a computer on-board the vehicle operably connected to the RFID interrogator, the computer being programmed to accept the speed bump notification signal from the RFID interrogator, and to issue commands turning on transducers to warn a driver of the vehicle of proximity to the speed bump;
a display unit in the vehicle operably connected to the computer, the display turning on a visual alert warning the driver of proximity to the speed bump in response to the computer's command;
an audio unit mounted in the vehicle, the audio unit being operably connected to the computer, the audio unit emitting an audible warning to the driver of the vehicle of proximity to the speed bump in response to the computer's command;
an external antenna operably connected to the RFID interrogator, the external antenna being adapted for mounting on any suitable exterior place of the vehicle's body and configured for transmitting and receiving signals on a frequency common to the interrogator and the RFID tag; and
a power source mounted in the vehicle, the interrogator being energized by the power source.

2. The speed bump alerting system according to claim 1, wherein said RFID interrogator is an ultra high frequency (UHF) interrogator adapted to interrogate an ultra high frequency (UHF) RFID tag mounted in proximity to the speed bump.

3. The speed bump alerting system according to claim 1, wherein said computer is programmed to issue commands turning on the transducers only when the speed bump notification signal also includes speed limit data corresponding to the speed bump and when the vehicle is exceeding the speed limit in the speed bump notification signal, and to turn off the transducers when the vehicle reduces speed to comply with the speed limit.

4. A speed bump alerting system for a vehicle on a roadway, comprising:
a wireless transponder located in proximity to a speed bump, the transponder configured to wirelessly transmit a notification signal of proximity to the speed bump;
an interrogator arranged on the vehicle for actuating the transponder and receiving the speed bump notification signal transmitted by the transponder; and
means for alerting a driver of the vehicle when the interrogator receives the speed bump notification signal.

5. The speed bump alerting system according to claim 3, wherein said wireless transponder is an ultra high frequency (UHF) RFID tag.

6. A speed bump alerting system kit, comprising:
an RFID interrogator adapted for being mounted in a vehicle, the RFID interrogator being operable for receiving a speed bump notification signal transmitted by a transponder mounted in proximity to a speed bump;
an external antenna adapted for operable connection to the RFID interrogator, the antenna being configured for operation on a frequency common to the interrogator and the transponder, the external antenna being adapted for mounting on the vehicle; and
means for alerting a driver of the vehicle upon receipt of the speed bump notification signal.

7. The speed bump alerting system kit according to claim 5, wherein said RFID interrogator is an ultra high frequency (UHF) interrogator adapted to interrogate an ultra high frequency (UHF) RFID tag mounted in proximity to the speed bump.
